(19) United States
(12) Patent Application Publication
(10) Pub. No.: US 2025/0252396 A1
(43) Pub. Date: Aug. 7, 2025

(54) INFORMATION PROCESSING DEVICE, INFORMATION PROCESSING METHOD, AND COMPUTER PROGRAM PRODUCT

(71) Applicants: KABUSHIKI KAISHA TOSHIBA, Tokyo (JP); TOSHIBA INFRASTRUCTURE SYSTEMS & SOLUTIONS CORPORATION, Kawasaki-shi (JP)

(72) Inventors: Takufumi YOSHIDA, Funabashi Chiba (JP); Yacheng WANG, Shinjuku Tokyo (JP); Atsushi MATSUMURA, Yokohama Kanagawa (JP)

(73) Assignees: KABUSHIKI KAISHA TOSHIBA, Tokyo (JP); TOSHIBA INFRASTRUCTURE SYSTEMS & SOLUTIONS CORPORATION, Kawasaki-shi, Kanagawa (JP)

(21) Appl. No.: 19/045,010

(22) Filed: Feb. 4, 2025

(30) Foreign Application Priority Data
Feb. 6, 2024 (JP) 2024-016146

(51) Int. Cl. G06Q 10/087; B65G 1/137

(52) U.S. Cl. CPC G06Q 10/087; B65G 1/1373

(57) ABSTRACT

According to one embodiment, an information processing device includes one or more hardware processors. The one or more processors are configured to: assign each of a plurality of orders including first identification information for identifying one or more types of products, to one of a plurality of batches; calculate, for each of the batches, a first workload of a first system that processes products of the first identification information included in the corresponding batch by a first unit, and a second workload of a second system that processes the products of the first identification information included in the corresponding batch by a second unit that is a unit whose number is different from a number of products to be processed by the first unit; and modify the orders included in the batches based on the first and second workloads.

### CROSS-REFERENCE TO RELATED APPLICATIONS

This application is based upon and claims the benefit of priority from Japanese Patent Application No. 2024-016146, filed on Feb. 6, 2024; the entire contents of which are incorporated herein by reference.

### FIELD

Embodiments described herein relate generally to an information processing device, an information processing method, and a computer program product.

### BACKGROUND

A total picking method and a single picking method are known as methods for picking products in distribution warehouses and the like. The total picking method is a method for reducing the number of times of picking, by aggregating and picking a plurality of products to a plurality of destinations. In this case, a sorting system in the post process sorts the products by delivery destination. The single picking method is a method for picking products in units of delivery destinations, and the picked products can be shipped as they are. That is, sorting is not necessary.

As described above, in the total picking method, the picking system that performs picking processes products in units of aggregated products (aggregate unit), but the sorting system processes products in units of one product (individual unit).

In the conventional technology, the difference in units of processing products between a plurality of systems (for example, picking system and sorting system) is not taken into account. Hence, the work efficiency of the entire system including the plurality of systems may be reduced.

### BRIEF DESCRIPTION OF THE DRAWINGS

FIG. 1 is a block diagram of a logistics system of an embodiment;

FIG. 2 is a block diagram of an information processing device of the embodiment;

FIG. 3 is a diagram illustrating an example of a table definition of shipment order information;

FIG. 4 is a diagram illustrating an example of a table definition of specification information;

FIG. 5 is a diagram illustrating an example of a table definition of product master information;

FIG. 6 is a diagram illustrating an example of a table definition of picking station information;

FIG. 7 is a diagram illustrating an example of a table definition of sorter master information;

FIG. 8 is a diagram illustrating an example of a table definition of work subject master information;

FIG. 9 is a diagram illustrating an example of a table definition of total picking conversion information;

FIG. 10 is a diagram illustrating an example of a table definition of total picking workload information;

FIG. 11 is a flowchart of information processing of the embodiment;

FIG. 12 is a diagram for explaining an example of the information processing of the embodiment; and

FIG. 13 is a hardware configuration diagram of the information processing device of the embodiment.

### DETAILED DESCRIPTION

In general, according to one embodiment, an information processing device includes one or more hardware processors. The one or more processors are configured to: assign each of a plurality of orders including first identification information for identifying one or more types of products, to one of a plurality of batches; calculate, for each of the plurality of batches, a first workload of a first system including a system that processes products of the first identification information included in the corresponding batch by a first unit, and a second workload of a second system including a system that processes the products of the first identification information included in the corresponding batch by a second unit, the second unit being a unit whose number is different from a number of products to be processed by the first unit; and modify the orders included in the plurality of batches, based on the first workload and the second workload.

Exemplary embodiments of an information processing device will be explained below in detail with reference to the accompanying drawings. The present invention is not limited to the following embodiments.

In the following, a logistics system including a picking system and a sorting system (hereinafter referred to as a “logistics system DS”) will be described as an example. However, a system to which the embodiment is applicable, is not limited to such a logistics system, and may be any other system including multiple systems in which units for processing target products are different from each other.

The outline of the processing flow in the logistics system DS will be described. For example, in the logistics system DS, the process of each system is performed by the following procedure.
(S1) Obtain information on a plurality of shipment orders. Each shipment order includes information on one or more types of products.
(S2) Create the number of batches according to the batch size of the sorter (device used for sorting products) provided in the sorting system, and the obtained shipment order number. The batch size is the number of shipment orders that can be processed by the sorter.
(S3) Determine the shipment order to be assigned to each batch so that the shipment orders including products of the same type are included in the same batch, and that the products can be shipped by the processing deadline of each shipment order.
(S4) Each system (picking system and sorting system) is operated so that the batch including the determined shipment order is processed as a unit.

With the function of (S3) described above, it is possible to pick products of the same type by the aggregate unit, and improve the conveyance and picking efficiencies of products by the aggregation effect. Moreover, the process can be completed (delivery date can be met) before the processing deadline of each shipment order.

The aggregation effect corresponds to the work efficiency obtained by grouping products of the same type in the shipment orders assigned to the batches. For example, a conveyance system that conveys products for picking can take out products from the inventory of products stored in a storage system by the aggregate unit to convey the products. Consequently, the number of times of conveyance is reduced with the increase in the number of products included in the aggregate unit, and thereby making it possible to reduce the lead time. Similarly, an operator who performs picking can pick products in groups by the aggregate unit. Thus, the number of times of picking is reduced with the increase in the number of products included in the aggregate unit, and thereby making it possible to reduce the lead time.

The number of products included in the aggregate unit may be a fixed value or may not be a fixed value. For example, if the work subject is a person (operator), the operator can pick products of two through the upper limit value, both inclusive, at a time. In such a case, the number of products included in the aggregate unit may vary. The upper limit value depends on the size of the product, the number of products that can be stored in a container (such as a shelf) for storing the products to be picked, and the like.

On the other hand, in automated picking using a robot, the robot often grips and picks products one at a time (individual unit). Thus, when picking is performed by a robot, the lead time often depends on the quantity (hereinafter also referred to as the individual product number) of product (hereinafter, may be referred to as an individual product) by the individual unit, instead of the number of products included in the aggregate unit. Similarly, the sorter used in the sorting process often moves products one at a time, and stores the products in a container (such as a cart) corresponding to the shipment order. Thus, the lead time often depends on the individual product number.

For example, in the logistics system DS, the operator, who is a subject of picking, picks products by the aggregate unit. However, in the sorting system, a plurality of picked products are sorted by the individual unit. Therefore, if the workload in each system is adjusted without taking into account the unit of processing products such as the above (hereinafter “work unit”), the work efficiency of the entire logistics system DS may not be improved. For example, if shipment orders to be assigned to the batches are determined without taking into account the work unit, the workload may vary between the batches, and congestion may occur between the picking process and the sorting process. If the congestion occurs, the shipping efficiency may be reduced, the sorter may be stopped, or the like.

Moreover, each system may include a plurality of subsystems with different work units. For example, a picking system may include a subsystem in which the subject is a person (operator) and that picks products by the aggregate unit, and a subsystem in which the subject is a picking robot and that picks products by the individual unit. In such a case, it is preferable to adjust the workload of each subsystem, by taking into account the difference in the work units between the subsystems.

For example, as a part of a White Logistics Promotion, picking robots have been introduced to save manpower in warehouses. Picking performed by a picking robot is different from picking performed by a person (operator) in that the types of products that can be processed (products defined as objects to be processed) are limited, and that the products are processed by individual units. In the logistics system DS that includes the subsystems with different work units such as a picking robot and an operator, the workload may vary and the work efficiency may be reduced, if a work instruction is issued without taking in account the difference in the work units.

In the present embodiment, mainly with the following functions, the work efficiency of the entire system including multiple systems will be improved.
(F1) The assignment of shipment orders to each batch is modified so that the workload in the work units of the aggregate unit and individual unit is leveled between the batches (batch-to-batch leveling function).
(F2) In a system including multiple subsystems with different work units, the workload is distributed to each work subject so that the workload is leveled according to the work units of the work subjects for each batch (work subject-to-work subject leveling function).

If a system including multiple subsystems with different work units is not used, the function of (F2) described above need not be provided. For example, if (F2) is provided, it is possible to level the workload between the operator and robot, by taking into account the difference between the work units. That is, it is possible to optimize the cooperation between the person (operator) and the robot.

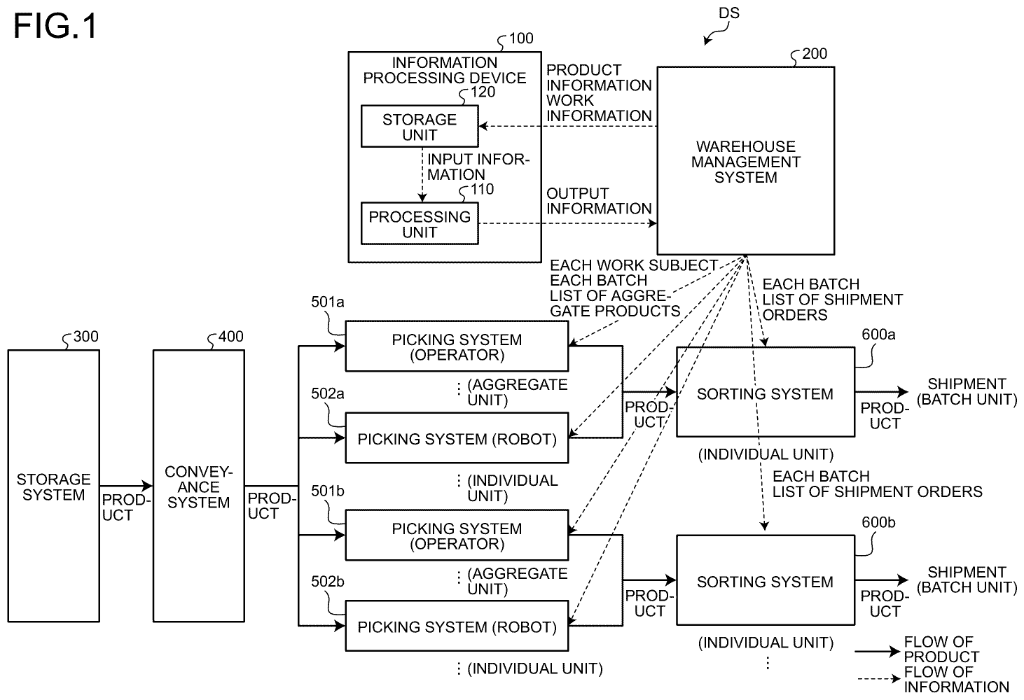

FIG. 1 is a block diagram illustrating an example of a configuration of the logistics system DS of the embodiment. As illustrated in FIG. 1, the logistics system DS includes an information processing device 100, a warehouse management system 200, a storage system 300, a conveyance system 400, a plurality of picking systems 501a, 501b, 502a, and 502b, and a plurality of sorting systems 600a and 600b.

The storage system 300 is a system that stores a plurality of products to be shipped. For example, the storage system 300 is a distribution warehouse where it is assumed that the shipment process is performed using the total picking method or the like. The storage system 300 includes shelves, stockers, or the like that store products.

The conveyance system 400 is a system that takes out the products according to the shipment order for each delivery destination from the storage system 300, and that conveys the products. For example, the conveyance system 400 includes a shelf conveyance robot (Automatic Guided Vehicle (AGV)), a high-rise rack robot (Autonomous Case-handling Robot (ACR)), and the like.

The picking systems 501a, 501b, 502a, and 502b are systems that pick the required quantity of products from the products conveyed by the conveyance system 400. The picking systems 501a, 501b, 502a, and 502b correspond to a system SYS1 (first system) including a system that processes products by a work unit U1 (first unit).

Moreover, the picking system in FIG. 1 corresponds to a system including multiple subsystems with different work units. For example, the picking systems 501a and 501b correspond to a subsystem SS1 (first subsystem) that processes products by the work unit U1. The picking systems 502a and 502b correspond to a subsystem SS2 (second subsystem) that process products by a work unit U3 (third unit) whose number is different from the number of products to be processed by the work unit U1. In the example of FIG. 1, the work unit U1 is an aggregate unit, and the work unit U3 is an individual unit.

In FIG. 1, the picking systems 501a and 501b are operators who pick products by the aggregate unit (work unit U1). The picking systems 502a and 502b are picking robots that pick products by the individual unit (work unit U3). The picking systems 501a and 501b are referred to as a picking system 501 when there is no need to distinguish between the two. The picking systems 502a and 502b are referred to as a picking system 502 when there is no need to distinguish between the two.

The sorting system 600a sorts the products picked by the picking system 501a or 502a by delivery destination and by shipment order, and ships the products by batch units. The sorting system 600b sorts the products picked by the picking system 501b or 502b by delivery destination and by shipment order, and dispatches the products by batch units. For example, the sorting systems 600a and 600b each include a sorter and the like. The sorting systems 600a and 600b are referred to as a sorting system 600 when there is no need to distinguish between the two.

The sorting system 600 corresponds to a system SYS2 (second system) including a system that processes products by a work unit U2 (second unit) whose number is different from the number of products to be processed by the work unit U1. In the example of FIG. 1, the work unit U2 is an individual unit.

In FIG. 1, there are two pairs of the sorting system 600 and two picking systems 501 and 502. However, the number of pairs may also be one or three or more. In the present embodiment, a process, such as assigning a shipment order to a batch, is performed per pair. In the following, a process performed on one pair will be mainly described. The same process is applied to the other pair.

Moreover, the number of picking systems 501 and the number of picking systems 502 included in each pair may also be two or more. Furthermore, the picking systems 501 and 502 need not be an operator and a picking robot, and any combination of picking systems may be used, as long as the work units are different from each other.

The warehouse management system 200 is a system that communicates with each system/device in the logistics system DS, and manages information in the entire logistics system DS. For example, the warehouse management system 200 transmits product information that is information on products, and work information related to the operation in each system to the information processing device 100, and causes the information processing device 100 to execute the process. Details of the product information and work information will be described below.

The information processing device 100 is a device (order management system) that manages shipment orders, such as determining the shipment order per batch to be processed by each system, using the product information and work information obtained from the warehouse management system 200. For example, the information processing device 100 performs the functions of (F1) and (F2) described above.

The information processing device 100 outputs the output information including information on the shipment order per batch, to the warehouse management system 200. By using the output information, the warehouse management system 200 outputs work instructions to the picking systems 501 and 502, and the sorting system 600. For example, the work instruction to the picking systems 501 and 502 is a list of aggregate products for each work subject and for each batch. For example, the work instruction to the sorting system 600 is a list of shipment orders for each batch.

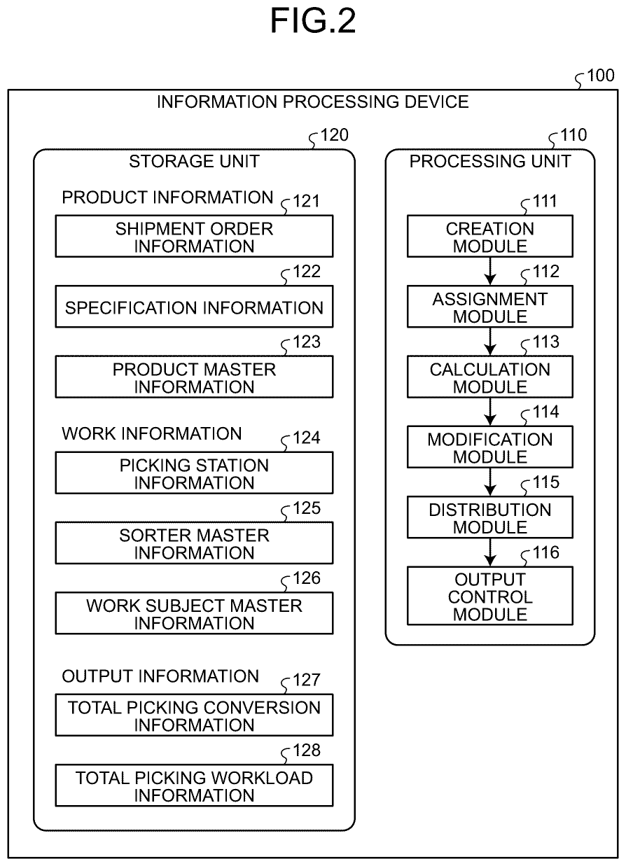

The information processing device 100 includes a processing unit 110 and a storage unit 120. The detailed configuration of the processing unit 110 and the storage unit 120 will be further described with reference to FIG. 2. FIG. 2 is a block diagram illustrating an example of a configuration of the information processing device 100 of the embodiment.

The storage unit 120 stores various types of information used in the information processing device 100. For example, the storage unit 120 stores the product information and work information obtained from the warehouse management system 200, and the output information output to the warehouse management system 200.

In FIG. 2, the product information includes shipment order information 121, specification information 122, and product master information 123. The work information includes picking station information 124, sorter master information 125, and work subject master information 126. The output information includes total picking conversion information 127 and total picking workload information 128. Hereinafter, an example of data configuration of each information stored in the storage unit 120 will be described.

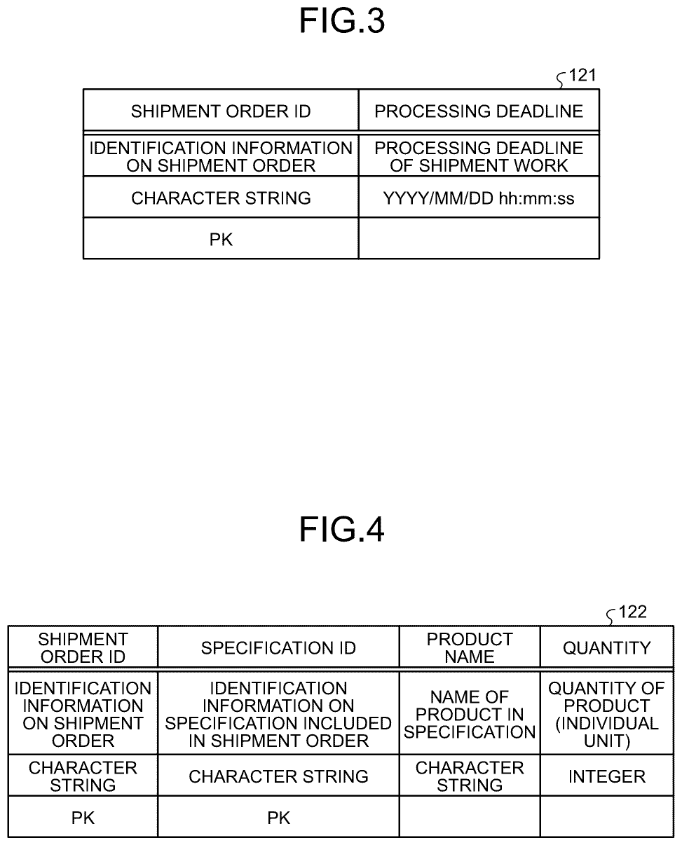

FIG. 3 is a diagram illustrating an example of a table definition of the shipment order information 121. The first line indicates the names of items contained in the information (shipment order information 121), the second line indicates the description of each item, the third line indicates the data type of each item, and the fourth line indicates whether each item is the primary key (PK). The same applies to FIG. 4 to FIG. 10 below. Moreover, FIG. 3 to FIG. 10 are examples indicating each data in a table format. However, the data structure is not limited to the table format, and may be in any format. For example, each information may also be stored in a format such as a CSV file and a JSON file.

As illustrated in FIG. 3, the shipment order information 121 includes the shipment order ID and processing deadline. In the shipment order information 121, the shipment order ID is set as the primary key (PK). The shipment order ID is identification information for identifying the shipment order. The processing deadline represents the deadline (closing date and time) for shipping the shipment order.

FIG. 4 is a diagram illustrating an example of a table definition of the specification information 122. As illustrated in FIG. 4, the specification information 122 includes the shipment order ID, specification ID, product name, and quantity. In the specification information 122, the shipment order ID and the specification ID are set as the primary key.

The specification ID is identification information for identifying the specification included in the shipment order. The specification is defined for each type of ordered products. Therefore, the number of specifications is the number of types of ordered products. The product name is the name of the product corresponding to the specification. The product name corresponds to the identification information for identifying the product. The quantity is the number of ordered products.

In the specification information 122, information corresponding to one shipment order ID corresponds to one order including the product name (first identification information) for identifying one or more types of products.

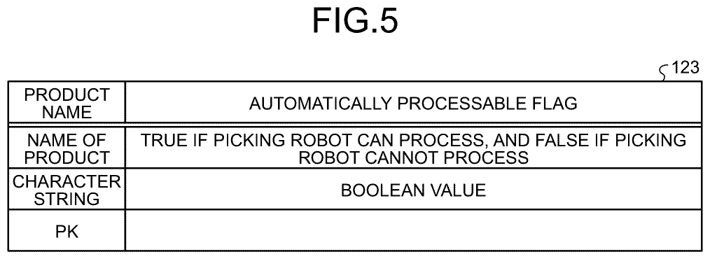

FIG. 5 is a diagram illustrating an example of a table definition of the product master information 123. As illustrated in FIG. 5, the product master information 123 includes the product name and an automatically processable flag. In the product master information 123, the product name is set as the primary key.

The automatically processable flag is set to “True”, if the picking robot is capable of processing, and is set to “False”, if the picking robot is not capable of processing. The automatically processable flag may be interpreted as information indicating whether the product is defined as an object to be processed by the picking robot.

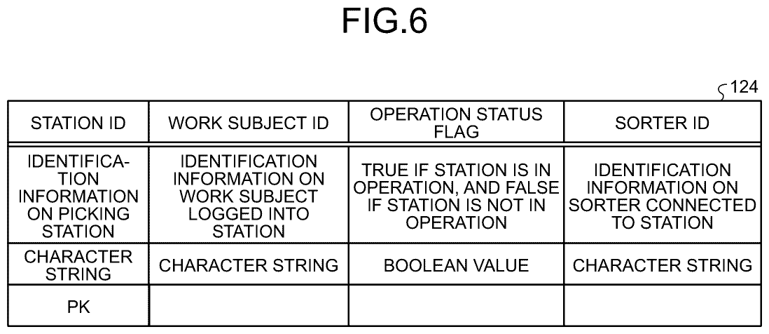

FIG. 6 is a diagram illustrating an example of a table definition of the picking station information 124. As illustrated in FIG. 6, the picking station information 124 includes the station ID, work subject ID, operation status flag, and sorter ID. In the picking station information 124, the station ID is set as the primary key.

The station ID is identification information for identifying the picking station. The picking station represents a location where picking work by the work subject (operator, picking robot, and the like) takes place. For example, the work subject is assigned (also referred to as logged in) to one of the picking stations, and performs picking work at the assigned picking station.

The work subject ID is identification information for identifying the work subject assigned (currently logged in) to the station identified by the station ID. The operation status flag is set to “True”, if the station is in operation (is being operated by the work subject), and set to “False”, if the station is not in operation (inactive).

The sorter ID is identification information for identifying the sorter connected to the picking station. As illustrated in FIG. 1, the picking station (picking system) and the sorter (sorting system) have an N-to-one correspondence (N is an integer equal to or greater than 1). This correspondence is defined by the picking station information 124.

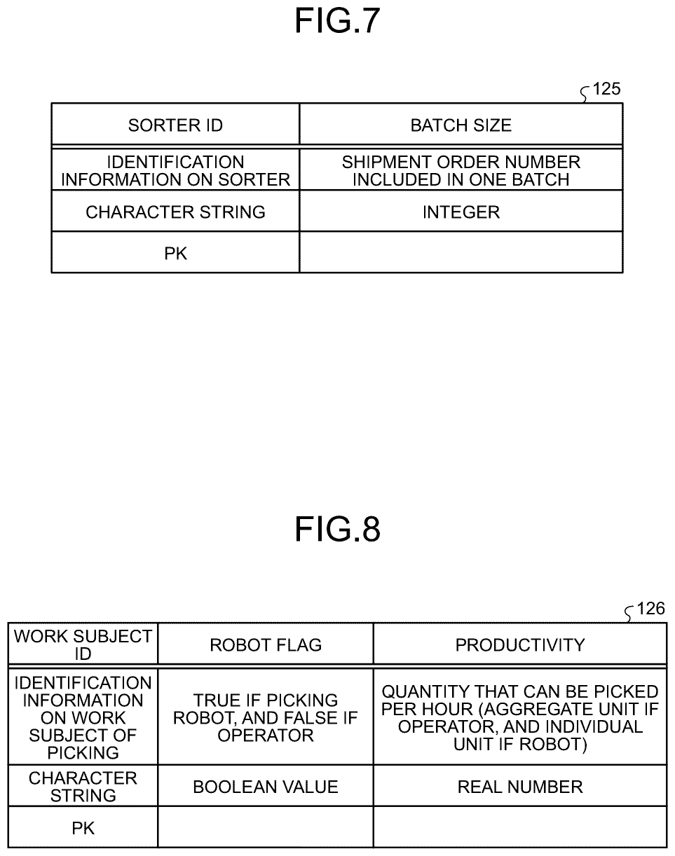

FIG. 7 is a diagram illustrating an example of a table definition of the sorter master information 125. As illustrated in FIG. 7, the sorter master information 125 includes the sorter ID and batch size. In the sorter master information 125, the sorter ID is set as the primary key.

The batch size is the number of shipment orders dispatched from the sorter at a time. For example, the batch size depends on the capacity of the container (dispatching cart) to which products are dispatched. Thus, the batch size of each sorter (sorter ID) is registered in the sorter master information 125.

FIG. 8 is a diagram illustrating an example of a table definition of the work subject master information 126. As illustrated in FIG. 8, the work subject master information 126 includes the work subject ID, a robot flag, and productivity. In the work subject master information 126, the work subject ID is set as the primary key.

The robot flag is set to “True”, if the work master is a picking robot, and set to “False”, if the work subject is not a picking robot (such as an operator).

The productivity represents the productivity of work performed by the work subject, and for example, is the quantity of product that can be picked per hour. The quantity is the quantity of product in aggregate units, if the work subject is an operator, and the quantity of product in individual units (the individual product number), if the work subject is a picking robot.

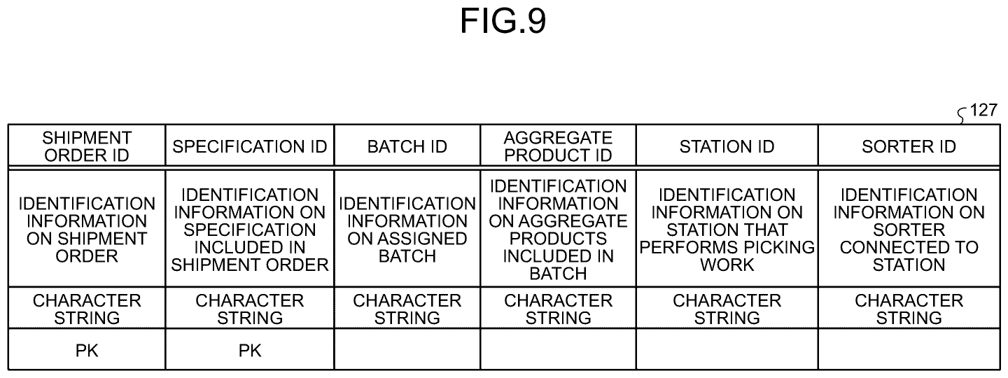

FIG. 9 is a diagram illustrating an example of a table definition of the total picking conversion information 127. As illustrated in FIG. 9, the total picking conversion information 127 includes the shipment order ID, specification ID, batch ID, aggregate product ID, station ID, and sorter ID. In the total picking conversion information 127, the shipment order ID and the specification ID are set as the primary key.

The batch ID is the batch ID of the batch assigned to the shipment order ID by the processing unit 110. The aggregate product ID is identification information for identifying the aggregate products. The aggregate product corresponds to the unit in which products of the same type included in the batch assigned to the shipment order ID are aggregated. The station ID is the station ID of the picking station assigned to the batch with the corresponding the batch ID. The sorter ID is the sorter ID of the sorter corresponding to the picking station of the station ID.

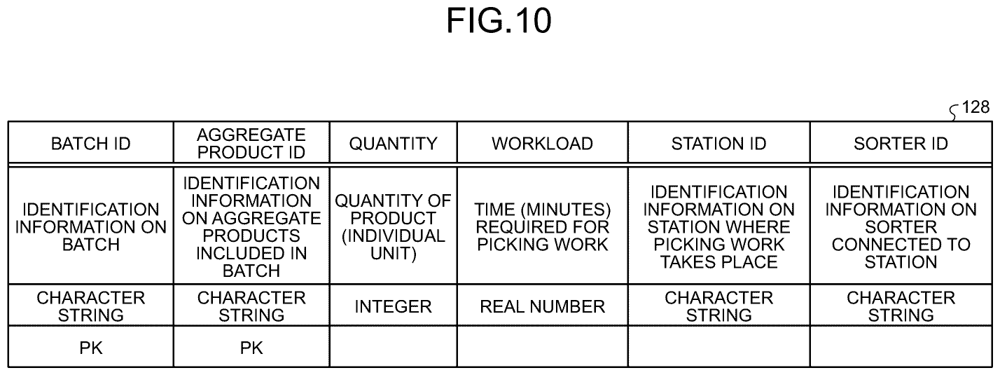

FIG. 10 is a diagram illustrating an example of a table definition of the total picking workload information 128. As illustrated in FIG. 10, the total picking workload information 128 includes the batch ID, aggregate product ID, quantity, workload, station ID, and sorter ID. In the total picking workload information 128, the batch ID and the aggregate product ID are set as the primary key.

The quantity represents the quantity of product included in the aggregate products identified by the aggregate product ID in individual units. The workload is the time required for the picking work. For example, if the work subject to which the aggregate products are distributed is an operator, the workload is calculated by 1/(productivity)×60. For example, if the work subject to which the aggregate products are distributed is a picking robot, the workload is calculated by (quantity)/(productivity)×60.

The total picking workload information 128 corresponds to supplementary information used to confirm or evaluate the processing results of the information processing device 100 (processing unit 110). For example, the total picking workload information 128 is calculated using the total picking conversion information 127 (FIG. 9) and the input information (FIG. 3 to FIG. 8) including the product information and work information.

The storage unit 120 can include any commonly used storage media such as a flash memory, a memory card, a random access memory (RAM), a hard disk drive (HDD), and an optical disc.

Some or all of the information stored in the storage unit 120 may be stored in physically different storage media, or may be stored in different storage areas in the physically same storage medium.

Returning to the explanation of FIG. 2. The processing unit 110 includes a creation module 111, an assignment module 112, a calculation module 113, a modification module 114, a distribution module 115, and an output control module 116.

The creation module 111 creates a plurality of batches to which the shipment orders are assigned, by referring to the obtained product information and work information. For example, the creation module 111 creates the batches, using the processing deadline of the shipment order included in the shipment order information 121, and the batch size included in the sorter master information 125.

First, the creation module 111 calculates the number of batches required for assigning the shipment orders identified by the shipment order ID included in the shipment order information 121. For example, the creation module 111 calculates an integer value obtained by dividing the number of shipment orders (shipment order IDs) by the batch size and rounding up the decimals, as the required number of batches. The creation module 111 creates the calculated number of batches, gives a batch ID to each batch, and gives a sequence to the batch in the dispatching order.

Moreover, the creation module 111 sets the upper limit of the processing deadline for each batch. For example, the creation module 111 sorts the shipment orders in the ascending order of processing deadlines, and sets the processing deadlines of shipment orders in the sequence corresponding to the multiple of the batch size, as the upper limits of the processing deadlines of the batches with the smaller dispatching sequences, in the ascending order. The method of setting the upper limit is not limited thereto, and any method may also be used. For example, the creation module 111 may set the upper limit specified by the user or like using an input screen.

The shipment order whose processing deadline is later than the upper limit cannot be assigned to the batches. Consequently, the delivery date of each shipment order can be met.

The assignment module 112 performs batch assignment that assigns each of a plurality of orders to one of the batches. For example, the assignment module 112 performs batch assignment so that the aggregation effect of the total picking method is maximized, while taking into account that the processing deadline of the shipment order is within the upper limit (that the shipment order can be assigned).

First, the assignment module 112 determines a candidate for a batch to which the orders are to be assigned, on the basis of the processing deadlines of the orders. For example, the assignment module 112 determines the batch the upper limit of which is set to the processing deadline of the order or longer, as a candidate for the batch to which the order is to be assigned. By repeating the process of determining the candidate for the batch such that the orders including the same products are more included in the determined candidate, the assignment module 112 determines the batch to which the orders are to be assigned.

For example, the assignment module 112 calculates the aggregation effect of each of the determined candidates for the batch. For example, the assignment module 112 calculates the aggregation effect by (specification number)/(aggregate product number). The specification number is the total number of specifications included in the candidates for the batch. The aggregate product number corresponds to the number of aggregate products, when products of the same type included in the candidates for the batch are aggregated and set as aggregate products.

For example, it is assumed that the following shipment orders including five specifications are assigned to the candidate for the batch. Products M1, M3, and M5 respectively represent different types of products.
Five products M1
Five products M3
Five products M5
Ten products M3
Five products M5

Any multiple products can be aggregated into aggregate products. In the example described above, the products are aggregated into three aggregate products corresponding to the products M1, M3, and M5. Thus, the aggregate product number is three, and the aggregation effect is calculated by 5/3.

For example, the assignment module 112 repeats the process (simulation) of determining the candidate for the batch to which each order is to be assigned, and calculating the aggregation effect, until the number of times of repetition reaches the upper limit. For example, the candidate for the batch to which the order is to be assigned, is randomly determined from the batches the upper limit of which is set to the processing deadline of the order or longer. The assignment module 112 determines the candidate that has the maximum aggregation effect when the number of times of repetition reaches the upper limit, as the batch to which the orders are to be assigned.

The batch assignment is not limited to the method of repeating simulations as described above, and any method may be used. For example, the assignment module 112 may use a clustering method to define the distance between two shipment orders as an inverse of the aggregation effect, and form batches in a hierarchical way, by repeating and forming groups of the shipment orders in close distance. For example, the distance may also be defined such that the distance is decreased with the increase in the closeness of the type of products.

The assignment module 112 may perform batch assignment, using a mathematical programming method (combinatorial optimization). For example, the assignment module 112 defines a model, by using a binary variable xᵢₖ that takes 1 when a shipment order i is assigned to a batch k, and that takes 0 otherwise. By calculating xᵢₖ that optimizes the aggregation effect of the model, using a mathematical programming solver or combinatorial optimization algorithm, the assignment module 112 performs batch assignment.

The following is an example of a model used by the assignment module 112. For example, under the conditions indicated in the following equation (1) to equation (4), the model obtains xᵢₖ that minimizes the sum of yᵢₖ as illustrated in equation (5).

$${\sum }_{k ∈ {K}_{i}} {x}_{ik} = 1 ( i ∈ I ) , {x}_{ik} = 0 ( i ∈ I , k ∈ \text{?} ) \qquad ( 1 )$$

$$\text{?} {x}_{ik} \leq B ( k ∈ K ) \qquad ( 2 )$$

$$\text{?} {c}_{ij} ( {x}_{ik} - {y}_{jk} ) \leq 0 ( j ∈ J , k ∈ K ) \qquad ( 3 )$$

$${x}_{ik} ∈ \{ 0 , 1 \} , {y}_{jk} ∈ \{ 0 , 1 \} \qquad ( 4 )$$

$${min}_{x , y} {\sum }_{j ∈ J , k ∈ K} {y}_{jk} \qquad ( 5 )$$

$$\text{?} \text{indicates text missing or illegible when filed}$$

Hereinafter, the definitions of variables used in each equation will be described:
xᵢₖ: 1 when the shipment order i is assigned to the batch k, and 0 otherwise;
yⱼₖ: 1 when the product j is included in the batch k, and 0 otherwise;
I: Set of the shipment orders I;
J: Set of the products j;
K: Set of the batches k;
Kᵢ: Set of the batches k the upper limit of which is the processing deadline of the shipment order i or longer (a bar of K₁ represents a complementary set);
B: Batch size; and
cᵢⱼ: Quantity of product j in the shipment order i.

Equation (1) represents that one of the batches k the upper limit of which is the processing deadline of the shipment order i or longer is selected. Equation (2) represents that the number of shipment orders included in the batch is equal to or less than the batch size. Equation (3) represents the equation related to the variable of the aggregate product that is y=1 when the quantity x is x>0. Equation (5) represents an equation that minimizes the aggregate product number.

In the present embodiment, the assignment of the shipment order to each batch is then further modified, by the batch-to-batch leveling function (F1 described above). The calculation module 113 and the modification module 114 perform the function corresponding to the batch-to-batch leveling function.

For each of the batches obtained by the batch assignment, the calculation module 113 calculates a workload W1 (first workload) and a workload W2 (second workload).

The workload W1 is the workload when the order included in the batch is processed by the system SYS1 (for example, the picking systems 501 and 502) including a system (for example, the picking system 501) that processes products by the work unit U1 (for example, aggregate unit). The workload W2 is the workload when the order included in the batch is processed by the system SYS2 (for example, the sorting system 600) including a system that processes products by the work unit U2 (for example, individual unit).

For example, the calculation module 113 calculates a value obtained by dividing the number of work units U1 included in the batch by the number of work units U1 to be processed by the system SYS1 per unit time, as the workload W1. Moreover, the calculation module 113 calculates a value obtained by dividing the number of work units U2 included in the batch by the number of work units U2 to be processed by the system SYS2 per unit time, as the workload W2.

If the work unit U1 is the aggregate unit, the number of work units U1 included in the batch corresponds to the aggregate product number included in the batch. If the work unit U2 is the individual unit, the number of work units U2 included in the batch corresponds to the individual product number included in the batch. For example, the individual product number can be calculated using the quantity included in the specification information 122.

If the system includes multiple subsystems, for each of the batches, the calculation module 113 further calculates a workload W3 (third workload) and a workload W4 (fourth workload) that are the workloads of the subsystems. The workload W3 is the workload when the order included in the batch is processed by the subsystem SS1 (for example, the picking system 501) that processes products by the work unit U1 (for example, aggregate unit). The workload W4 is the workload when the order included in the batch is processed by the subsystem SS2 (for example, the picking system 502) that processes products by the work unit U3 (for example, individual unit).

The modification module 114 modifies the results of batch assignment so as to level the calculated workloads W1 and W2 of each work unit. For example, the modification module 114 modifies the orders included in the batches so that the workload W1 and the workload W2 are leveled between the batches.

For example, the modification module 114 performs an exchange process that exchanges one or more orders included in a batch B1 (first batch) included in the batches, and one or more orders included in a batch B2 (second batch) included in the batches. The modification module 114 modifies the orders included in the batches, by performing the exchange process so that the difference in the workload W1 between the batch B1 and the batch B2 and the difference in the workload W2 between the batch B1 and the batch B2 become small when the exchange process is performed.

In this manner, the modification module 114 selects two batches from the batches, takes out one shipment order from each of the selected two batches, and calculates the effect when the shipment orders are exchanged (hereinafter “exchange effect”). As described above, the exchange effect includes the difference in the workload W1 (for example, the difference in the workload in the aggregate unit), and the difference in the workload W2 (for example, the difference in the workload in the individual unit). The exchange effect is an index in which the value is increased with a decrease in the difference. That is, by performing the exchange process so that the exchange effect is increased, it is possible to level the workload W1 and the workload W2 between the batches.

The exchange process may reduce the aggregation effect. Thus, the exchange effect may further include an index in which the value is increased with the decrease in the aggregation effect in each batch.

If the exchange effect satisfies the condition, the modification module 114 outputs the result of the exchange process as the corrected result of the batch assignment. For example, the condition includes that the exchange effect is greater than a threshold value or the like. If the exchange effect does not satisfy the condition, the modification module 114 may repeat the exchange process until the exchange effect satisfies the condition. The number of batches and shipment orders to be exchanged is not limited to two, and may be three or more.

Any method may be applied to select the batches to be exchanged, and to select the shipment order from the selected batch. However, for example, the following method is applicable.
Select at random
Select batches or shipment orders with a large difference in the individual product number or the aggregate product number.

In the case of a system including multiple subsystems with different work units, the work subject-to-work subject leveling function (F2 described above) will be performed. The distribution module 115 performs the function corresponding to the work subject-to-work subject leveling function.

For each of the batches, the distribution module 115 distributes the products included in the batch to multiple subsystems (for example, the subsystem SS1 and the subsystem SS2) so that the workload W3 and the workload W4 are leveled.

For example, on the basis of the results of the current batch assignment, the distribution module 115 determines the distribution of products to the work subject in aggregate units in each batch. First, the distribution module 115 creates an aggregate unit by aggregating the specifications of the same products in each batch, and calculates the workload when the products are distributed to each work subject by the aggregate unit. For example, by using the quantity obtained by summing the products in the aggregate unit and the productivity of the work subject (processable number per hour), the distribution module 115 calculates the workload by workload (minutes)=1/(productivity)×60 if the work subject is an operator, and by workload (minutes)=(quantity)/(productivity)×60 if the work subject is a picking robot. With reference to the calculated workload, the distribution module 115 determines the distribution of the aggregate products so that the workload (minutes) of the work subjects is leveled. For example, the productivity used to calculate the workload can be obtained from the work subject master information 126.

In the following example, the subsystems are the subsystem SS1 (for example, the picking system 501) that processes products by the work unit U1, and the subsystem SS2 (for example, the picking system 502) that processes products by the work unit U3. Moreover, in the example, the work unit U1 is the aggregate unit and the work unit U3 is the individual unit. That is, it is assumed that the number of products processed by the work unit U3 is smaller than the number of products processed by the work unit U1.

The distribution module 115 performs distribution by taking into account the condition of the aggregate products that can be processed by the picking robot. For example, as the distribution method, there is a method of first distributing all aggregate products that can be processed by the picking robot to the picking robot and distributing the other aggregate products to the operator, and if the workload of the picking robot is greater than that of the operator, the workload is leveled by preferentially redistributing the aggregate products with a large quantity again to the operator.

That is, the distribution module 115 first distributes the products M1 (first product) other than the products M2 (second product) defined as objects to be processed by the subsystem SS2 and distributes the products M2 to the subsystem SS2, among the products included in the batch to the subsystem SS1. And then, if the workload W4 is greater than the workload W3, the distribution module 115 redistributes some of the products M2 to the subsystem SS1. For example, whether the picking robot can process the products can be determined by the automatically processable flag in the product master information 123.

The distribution method is not limited to the above, and any method may be used, as long as the method can distribute products so that the workload of the work subjects is leveled. For example, the distribution module 115 may use a method of obtaining the more leveled result, by modifying the distribution of products between the picking robot and the operator, and repeating the simulation.

The distribution module 115 may distribute products by using mathematical optimization (combinatorial optimization). For example, the distribution module 115 defines a model using a binary variable Zₙₘ that takes 1 when aggregate products n are distributed to a work subject m, and that takes 0 otherwise. The distribution module 115 distributes products to the work subject, by calculating Zₙₘ that optimizes the leveling effect of the model, using a mathematical programming solver or combinatorial optimization algorithm.

Hereinafter, an example of a model used by the distribution module 115 will be described. For example, under the conditions indicated in the following equation (6) to equation (8), the model obtains Zₙₘ that minimizes the sum of tₖ as illustrated in equation (9).

$${\sum }_{m ∈ M} {z}_{nm} = 1 ( n ∈ {N}_{k} ) \qquad ( 6 )$$

$$\text{?} {a}_{nm} {z}_{nm} \leq {t}_{k} ( m ∈ M ) \qquad ( 7 )$$

$${z}_{nm} ∈ \{ 0 , 1 \} \qquad ( 8 )$$

$${min}_{z , t} {t}_{k} \qquad ( 9 )$$

$$\text{?} \text{indicates text missing or illegible when filed}$$

Hereinafter, the definitions of variables used in each equation will be described.
zₙₘ: 1 when the aggregate products n are assigned to the work subject m, and 0 otherwise
Nₖ: Set of the aggregate products n in the batch k
M: Set of the working subjects m
aₙₘ: Time of picking the aggregate products n by the work subject m

Equation (6) represents that the aggregate products n are assigned to one of the work subjects m. Equation (7) represents that the picking time of the work subject whose total picking time is the longest, among all the work subjects m, is within the batch completion time. Equation (9) represents the equation for minimizing the batch completion time tₖ.

The output control module 116 controls the output of various types of information used by the information processing device 100. For example, the output control module 116 outputs output information (first output information) including the batch ID of a batch to which the order is assigned, for each of the orders, to the warehouse management system 200. For example, the output information is the total picking conversion information 127 illustrated in FIG. 9. The output control module 116 may output the total picking workload information 128 illustrated in FIG. 10, as the output information.

For example, the units (creation module 111, assignment module 112, calculation module 113, modification module 114, distribution module 115, and output control module 116) included in the processing unit 110 are implemented by one or more hardware processors. For example, each unit described above may be implemented by causing a processor such as a central processing unit (CPU) and a graphics processing unit (GPU) to execute a computer program, that is, by software. Each unit described above may be implemented by a processor such as a dedicated integrated circuit (IC), that is, by hardware. Each unit described above may be implemented by combining software and hardware. If the processors are used, each of the processors may implement one of the units, or may implement two or more of the units.

Moreover, the information processing device 100 may be physically composed of one device, or may be physically composed of a plurality of devices. For example, the information processing device 100 may be built on a cloud environment. Moreover, the units in the information processing device 100 may be distributed over the devices.

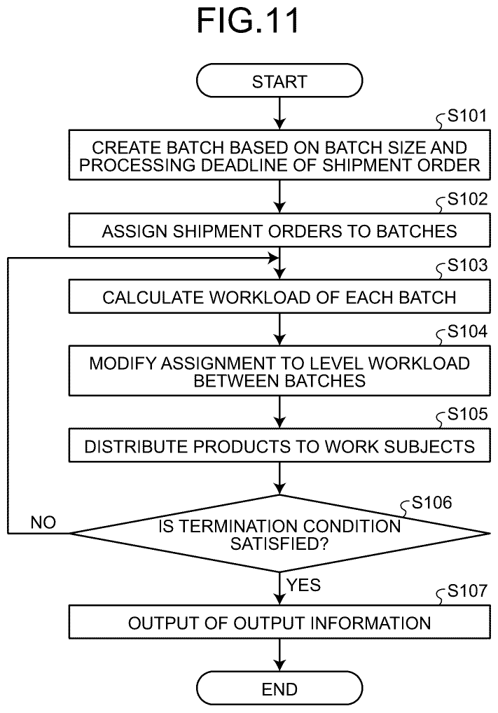

Next, information processing performed by the information processing device 100 of the embodiment will be described. FIG. 11 is a flowchart illustrating an example of information processing of the embodiment.

The creation module 111 creates a plurality of batches on the basis of the batch size and the processing deadline of the shipment order (step S101). The assignment module 112 performs batch assignment that assigns each of the shipment orders to one of the batches (step S102).

Hereinafter, by repeating step S103 to step S106, the batch-to-batch leveling function (F1), and the work subject-to-work subject leveling function (F2) will be performed.

First, the calculation module 113 calculates the workload W1 (first workload) and the workload W2 (second workload) for each of the batches obtained by batch assignment (step S103). The modification module 114 modifies the orders assigned to the batches so as to level the workload between the batches (step S104). For each of the batches, the distribution module 115 distributes the products included in the batch to the work subjects (subsystems) so that the workload W3 and the workload W4 are leveled (step S105).

The processing unit 110 determines whether the termination condition of the batch assignment calculation is satisfied (step S106). If the termination condition is not satisfied (No at step S106), the process returns to step S103 to repeat the process. If the termination condition is satisfied (Yes at step S106), for example, the output control module 116 outputs output information such as the total picking conversion information 127 (step S107), and terminates the information processing.

For example, the termination condition includes one of the following conditions.
The number of times of repetition exceeds a predetermined maximum number.
The assignment is not modified at step S104.
The improvement amount of the workload, the aggregate product number, or the individual product number per batch is less than a predetermined minimum improvement amount.

The parameters such as the maximum number and the minimum improvement amount may be set in any way. However, for example, the parameters may be set using the following methods.
Register in the setting file stored in the storage unit 120 and the like, and read out when the processing unit 110 starts processing.
Register as an environment variable of the operation system (OS) used by the information processing device 100, and reads out when the processing unit 110 starts processing.
Passed as an argument of the execution command of a computer program that implements the processing unit 110.

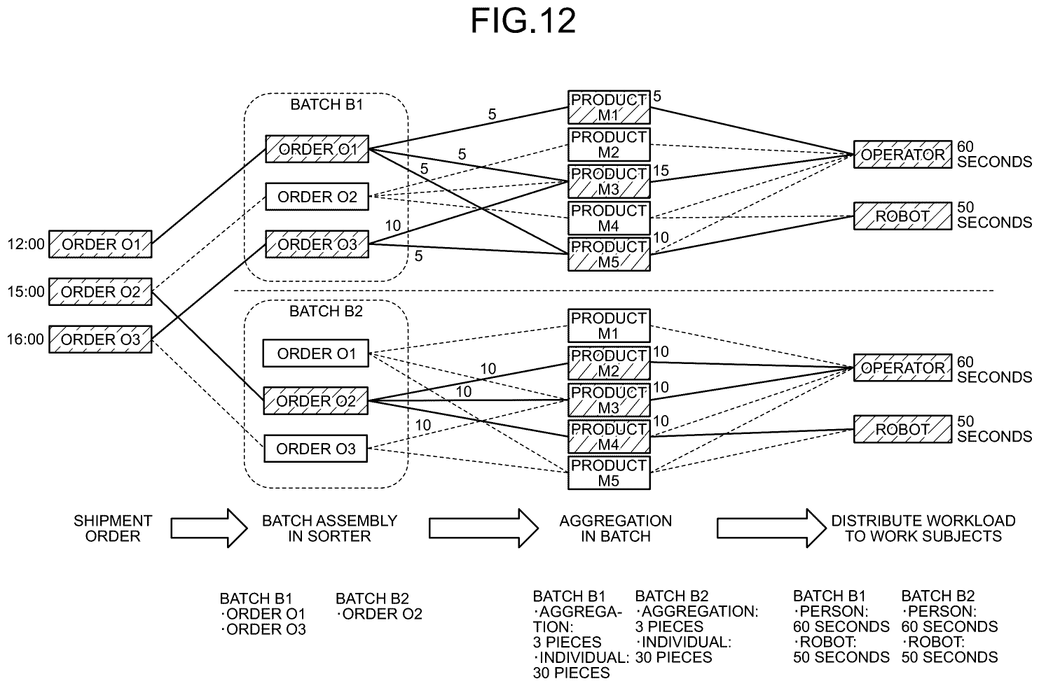

Next, an example of information processing (order management) in the present embodiment will be described with reference to FIG. 12. FIG. 12 is a diagram for explaining an example of information processing of the embodiment. FIG. 12 illustrates an example of the result when a process is performed to level the workload.

In the example of FIG. 12, three shipment orders whose shipment order IDs are an “order O1”, an “order O2”, and an “order O3” are input, as the shipment orders included in the shipment order information 121. The processing deadlines of the orders are “12:00”, “15:00”, and “16:00”. To simplify the description, the year, month, date, and seconds are omitted. Moreover, it is assumed that the batch size of the sorter included in the sorting system 600 is two.

Furthermore, it is assumed that each shipment order includes the following specification.
Order O1: The quantity of the products M1 is five, the quantity of the products M3 is five, and the quantity of the products M5 is five
Order O2: The quantity of the products M2 is ten, the quantity of the products M3 is ten, and the quantity of the products M4 is ten.
Order O3: The quantity of the products M3 is ten and the quantity of the products M5 is five

The creation module 111 creates batches to which the three shipment orders are assigned. Because the number of shipment orders is three, two batches (3/2=1.5, digits are rounded up) are created. Although not illustrated in FIG. 12, it is assumed that the time later than 16:00 (for example, 17:00) is set as the upper limit of the processing deadline of each batch. The batch IDs of the two batches are a “batch B1” and a “batch B2”.

The three orders are assigned to one of the two batches whose batch IDs are the “batch B1” and the “batch B2”. In the example of FIG. 12, the orders O1 and O3 are assigned to the batch of the batch B1, and the order O2 is assigned to the batch of the batch B2.

In this case, in each batch, products are aggregated as follows.
Batch B1: three aggregate products corresponding to the products M1, M3, and M5
Batch B2: three aggregate products corresponding to the products M2, M3, and M4

Moreover, the individual product number in each batch will be as follows.
Batch B1: 30 pieces (5 products M1, 15 products M3, and 10 products M5)
Batch B2: 30 pieces (ten products M2, ten products M3, and ten products M4)

Because the aggregate product number (three pieces) and the individual product number (30 pieces) in the two batches match with each other, the workload of the batches is leveled.

It is assumed that the productivity of the operator and the robot is two pieces/minute (aggregate unit) and 12 pieces/minute (individual unit), respectively. In this case, as illustrated in FIG. 12, the workload of the operator is 60 seconds, and the workload of the robot is 50 seconds.

For example, it is assumed that the work subjects of the product M3 and the product M5 are replaced for the batch B1. In this case, the workload of the operator is 60 seconds (2×60/2), and the workload of the robot is 75 seconds (15×60/12). Compared to this case, in the example of FIG. 12, the difference between the workloads is reduced (ten seconds), and the time of completing the batch processing is reduced. That is, in the example of FIG. 12, the workload between the operator and robot is leveled.

In the example described above, the systems that have different work units to each other are the picking system and the sorting system. However, the systems that have different work units to each other are not limited thereto, and any other combination of systems are applicable. For example, the systems may also be a sorting system that processes products in the individual unit, and a loading system that loads products onto vehicles or the like to covey the products to the shipment destination, in units in which the sorted shipment orders are grouped together.

An example in which the work unit U1 is the aggregate unit, the work unit U2 is the individual unit, and the work unit U3 is the individual unit has been mainly described. However, the combination of units is not limited thereto. Any combination of the work units U1 and U2 may be used, as long as the number of products to be processed differ from each other. Moreover, any combination of the work units U1 and U3 may be used, as long as the number of products to be processed differ from each other. For example, it is assumed that the subsystem SS1 is a picking robot that picks products by the unit of m pieces (m is an integer greater than or equal to 1), and the subsystem SS2 is a picking system that picks products by the unit of n pieces (n is an integer greater than or equal to 1 that satisfies m n). In this case, the work unit U1 may be the aggregate unit in which m pieces of products are aggregated, and the work unit U3 may be the aggregate unit in which n pieces of products are aggregated.

In this manner, the information processing device of the embodiment can improve the work efficiency of the entire system including multiple systems.

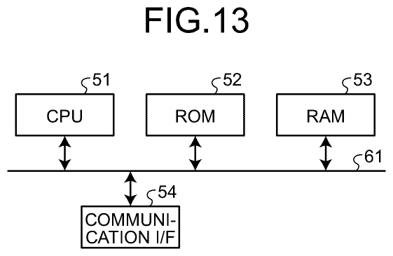

Next, a hardware configuration of the information processing device of the embodiment will be described with reference to FIG. 13. FIG. 13 is an explanatory diagram illustrating an example of a hardware configuration of the information processing device of the embodiment.

The information processing device of the embodiment includes a control unit such as a central processing unit (CPU) 51, a storage unit such as a read only memory (ROM) 52 and a random access memory (RAM) 53, a communication I/F 54 connected to a network for communication, and a bus 61 that connects the units.

A computer program executed by the information processing device of the embodiment is provided by being embedded in the ROM 52 or the like in advance.

The computer program executed by the information processing device of the embodiment may be recorded in a computer readable recording media such as a compact disc read only memory (CD-ROM), a flexible disk (FD), a compact disc recordable (CD-R), and a digital versatile Disc (DVD) in an installable or executable file format, and provided as a computer program product.

Moreover, the computer program executed by the information processing device of the embodiment may be stored on a computer connected to a network such as the Internet, and provided by being downloaded through the network. Furthermore, the computer program executed by the information processing device of the embodiment may be provided or distributed via a network such as the Internet.

The computer program executed by the information processing device of the embodiment can cause a computer to function as each unit of the information processing device described above. In the computer, the CPU 51 can read a computer program from a computer-readable storage medium onto the main storage device, and execute the computer program.

Configuration examples of the embodiment will be described below.

### Configuration Example 1

An information processing device comprising:
one or more hardware processors configured to:
   assign each of a plurality of orders including first identification information for identifying one or more types of products, to one of a plurality of batches;
   calculate, for each of the plurality of batches, a first workload of a first system including a system that processes products of the first identification information included in the corresponding batch by a first unit, and a second workload of a second system including a system that processes the products of the first identification information included in the corresponding batch by a second unit, the second unit being a unit whose number is different from a number of products to be processed by the first unit; and
   modify the orders included in the plurality of batches, based on the first workload and the second workload.

### Configuration Example 2

The information processing device according to Configuration example 1, wherein
the one or more hardware processors are configured to modify the orders included in the plurality of batches so that the first workload and the second workload are leveled between the plurality of batches.

### Configuration Example 3

The information processing device according to Configuration example 1, wherein
the one or more hardware processors are configured to modify the orders included in the batches, by performing an exchange process of exchanging one or more of the orders included in a first batch included in the plurality of batches and one or more of the orders included in a second batch included in the plurality of batches so that a difference of the first workload between the first batch and the second batch and a difference of the second workload between the first batch and the second batch are reduced when the exchange process is performed.

### Configuration Example 4

The information processing device according to any one of Configuration examples 1 to 3, wherein
the first system includes a first subsystem that processes the products of the first identification information included in the batch by the first unit, and a second subsystem that processes the products of the first identification information included in the batch by a third unit, the third unit being a unit whose number is different from the number of products to be processed by the first unit, and
the one or more hardware processors are configured to:
   calculate, for each of the plurality of batches, a third workload of the first subsystem and a fourth workload of the second subsystem when the products of the first identification information included in the batch are distributed to and processed in the first subsystem and the second subsystem; and
   distribute, for each of the plurality of batches, the products of the first identification information included in the batch to the first subsystem and the second subsystem, based on the third workload and the fourth workload.

### Configuration Example 5

The information processing device according to Configuration example 4, wherein
a number of products to be processed by the third unit is smaller than the number of products to be processed by the first unit, and
the one or more hardware processors are configured to:
   distribute first products other than second products defined as an object to be processed by the second subsystem to the first subsystem, and distribute the second products to the second subsystem, among the products of the first identification information included in the batch; and
   redistribute, when the fourth workload is greater than the third workload, some of the second products to the first subsystem.

### Configuration Example 6

The information processing device according to Configuration example 4, wherein
the first subsystem is a system that picks the products of the first identification information included in the batch by the first unit, and
the second subsystem is a system that picks the products of the first identification information included in the batch by the third unit.

### Configuration Example 7

The information processing device according to any one of Configuration examples 1 to 6, wherein
the one or more hardware processors are configured to:
   calculate, as the first workload, a value obtained by dividing number of the first unit included in the batch by number of the first unit processed by the first system per unit time; and
   calculate, as the second workload, a value obtained by dividing number of the second unit included in the batch by number of the second unit processed by the second system per unit time.

### Configuration Example 8

The information processing device according to any one of Configuration examples 1 to 6, wherein
the first system is a picking system that picks products by the first unit, and
the second system is a sorting system that sorts, by the second unit, the products picked by the picking system by the first unit.

### Configuration Example 9

The information processing device according to any one of Configuration examples 1 to 8, wherein
the one or more hardware processors are configured to determine, among the plurality of batches, a candidate for a batch to which the plurality of orders are to be assigned based on a processing deadline of the orders, and determine, among the plurality of batches, a batch to which the plurality of orders are to be assigned, by repeating a process of determining the candidate so that more orders including the same first identification information are included in the candidate.

### Configuration Example 10

The information processing device according to any one of Configuration examples 1 to 9, wherein
the one or more hardware processors are configured to output first output information including second identification information for identifying, for each of the orders, a batch to which the corresponding order is assigned among the plurality of batches.

### Configuration Example 11

An information processing method executed by an information processing device, the method comprising:
assigning each of a plurality of orders including first identification information for identifying one or more types of products, to one of a plurality of batches;
calculating, for each of the plurality of batches, a first workload of a first system including a system that processes products of the first identification information included in the corresponding batch by a first unit, and a second workload of a second system including a system that processes the products of the first identification information included in the corresponding batch by a second unit, the second unit being a unit whose number is different from a number of products to be processed by the first unit; and
modifying the orders included in the plurality of batches, based on the first workload and the second workload.

### Configuration Example 12

A computer program product comprising a computer-readable medium including programmed instructions, the instructions causing a computer to execute:
assigning each of a plurality of orders including first identification information for identifying one or more types of products, to one of a plurality of batches;
calculating, for each of the plurality of batches, a first workload of a first system including a system that processes products of the first identification information included in the corresponding batch by a first unit, and a second workload of a second system including a system that processes the products of the first identification information included in the corresponding batch by a second unit, the second unit being a unit whose number is different from a number of products to be processed by the first unit; and
modifying the orders included in the plurality of batches, based on the first workload and the second workload.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device comprising:
one or more hardware processors and configured to:
assign each of a plurality of orders including first identification information for identifying one or more types of products, to one of a plurality of batches;
calculate, for each of the plurality of batches, a first workload of a first system including a system that processes products of the first identification information included in the corresponding batch by a first unit, and a second workload of a second system including a system that processes the products of the first identification information included in the corresponding batch by a second unit, the second unit being a unit whose number is different from a number of products to be processed by the first unit; and
modify the orders included in the plurality of batches, based on the first workload and the second workload.

2. The information processing device according to claim 1, wherein
the one or more hardware processors are configured to modify the orders included in the plurality of batches so that the first workload and the second workload are leveled between the plurality of batches.

3. The information processing device according to claim 1, wherein
the one or more hardware processors are configured to modify the orders included in the batches, by performing an exchange process of exchanging one or more of the orders included in a first batch included in the plurality of batches and one or more of the orders included in a second batch included in the plurality of batches so that a difference of the first workload between the first batch and the second batch and a difference of the second workload between the first batch and the second batch are reduced when the exchange process is performed.

4. The information processing device according to claim 1, wherein
the first system includes a first subsystem that processes the products of the first identification information included in the batch by the first unit, and a second subsystem that processes the products of the first identification information included in the batch by a third unit, the third unit being a unit whose number is different from the number of products to be processed by the first unit, and
the one or more hardware processors are configured to:
calculate, for each of the plurality of batches, a third workload of the first subsystem and a fourth workload of the second subsystem when the products of the first identification information included in the batch are distributed to and processed in the first subsystem and the second subsystem; and
distribute, for each of the plurality of batches, the products of the first identification information included in the batch to the first subsystem and the second subsystem, based on the third workload and the fourth workload.

5. The information processing device according to claim 4, wherein
a number of products to be processed by the third unit is smaller than the number of products to be processed by the first unit, and
the one or more hardware processors are configured to:
distribute first products other than second products defined as an object to be processed by the second subsystem to the first subsystem, and distribute the second products to the second subsystem, among the products of the first identification information included in the batch; and
redistribute, when the fourth workload is greater than the third workload, some of the second products to the first subsystem.

6. The information processing device according to claim 4, wherein
the first subsystem is a system that picks the products of the first identification information included in the batch by the first unit, and
the second subsystem is a system that picks the products of the first identification information included in the batch by the third unit.

7. The information processing device according to claim 1, wherein
the one or more hardware processors are configured to:
calculate, as the first workload, a value obtained by dividing number of the first unit included in the batch by number of the first unit processed by the first system per unit time; and
calculate, as the second workload, a value obtained by dividing number of the second unit included in the batch by number of the second unit processed by the second system per unit time.

8. The information processing device according to claim 1, wherein
the first system is a picking system that picks products by the first unit, and
the second system is a sorting system that sorts, by the second unit, the products picked by the picking system by the first unit.

9. The information processing device according to claim 1, wherein
the one or more hardware processors are configured to determine, among the plurality of batches, a candidate for a batch to which the plurality of orders are to be assigned based on a processing deadline of the orders, and determine, among the plurality of batches, a batch to which the plurality of orders are to be assigned, by repeating a process of determining the candidate so that more orders including the same first identification information are included in the candidate.

10. The information processing device according to claim 1, wherein
the one or more hardware processors are configured to output first output information including second identification information for identifying, for each of the orders, a batch to which the corresponding order is assigned among the plurality of batches.

11. An information processing method executed by an information processing device, the method comprising:
assigning each of a plurality of orders including first identification information for identifying one or more types of products, to one of a plurality of batches;
calculating, for each of the plurality of batches, a first workload of a first system including a system that processes products of the first identification information included in the corresponding batch by a first unit, and a second workload of a second system including a system that processes the products of the first identification information included in the corresponding batch by a second unit, the second unit being a unit whose number is different from a number of products to be processed by the first unit; and
modifying the orders included in the plurality of batches, based on the first workload and the second workload.

12. A computer program product comprising a computer-readable medium including programmed instructions, the instructions causing a computer to execute:
assigning each of a plurality of orders including first identification information for identifying one or more types of products, to one of a plurality of batches;
calculating, for each of the plurality of batches, a first workload of a first system including a system that processes products of the first identification information included in the corresponding batch by a first unit, and a second workload of a second system including a system that processes the products of the first identification information included in the corresponding batch by a second unit, the second unit being a unit whose number is different from a number of products to be processed by the first unit; and
modifying the orders included in the plurality of batches, based on the first workload and the second workload.
